(19) United States
(12) Patent Application Publication
(10) Pub. No.: US 2015/0006295 A1
(43) Pub. Date: Jan. 1, 2015

(54) TARGETING USERS BASED ON PREVIOUS ADVERTISING CAMPAIGNS

(71) Applicant: Linkedln Corporation, Mountain View, CA (US)

(72) Inventors: Kun Liu, Sunnyvale, CA (US); Anmol Bhasin, Los Altos, CA (US); Sanjay C. Kshetramade, Fremont, CA (US); Meera G. Bhatia, San Francisco, CA (US)

(73) Assignee: Linkedln Corporation, Mountain View, CA (US)

(21) Appl. No.: 14/047,768

(22) Filed: Oct. 7, 2013

Related U.S. Application Data
(63) Continuation-in-part of application No. 13/931,471, filed on Jun. 28, 2013.

(51) Int. Cl. G06Q 50/00; G06Q 30/02

(52) U.S. Cl. CPC G06Q 50/01; G06Q 30/0269
USPC 705/14.66

(57) ABSTRACT

During a targeting technique, a machine-learning model is generated based on information about previous advertising campaigns and attributes in profiles of users of a social network (which facilitates interactions among the users). The information about the previous advertising campaigns includes specified target groups and associated feedback metrics obtained from individuals, such as impressions served, clicks and/or conversions. This machine-learning model is then used to calculate scores for the users based on attributes in their profiles and/or user behaviors (such as online activities) that indicate probabilities of their responding to a future advertising campaign for a target group. Moreover, based on the calculated scores, a subset of the users is associated with the target group. For example, the users may be ranked based on their calculated scores, and the subset may be those users having scores exceeding a threshold or a predefined value.

### CROSS-REFERENCE TO RELATED APPLICATIONS

This application is a continuation-in-part of U.S. patent application Ser. No. 14/045,206 (Attorney Docket No. LI-P0057.LNK.US), which is incorporated herein by reference. Also, this application is related to U.S. patent application Ser. No. ***, entitled “Targeting Users Based on Categorical Content Interactions” and filed ***, 2013 (Attorney Docket No. LI-P0057.LNK.CIP2), and U.S. patent application Ser. No. 1, entitled “Targeting Rules Based on Previous Recommendations” and filed Oct. 3, 2013 (Attorney Docket No. LI-P0057.LNK.CIP3), the contents of both of which are incorporated herein by reference.

### BACKGROUND

1. Field

The described embodiments relate to techniques for targeting the users of a social network based on responses to previous advertising campaigns.

2. Related Art

Advertising is a popular source of revenue for web pages and websites on the Internet. During an advertising campaign, advertising content associated with a product or a service is presented to a user, for example, across the top of a web page. A single serving of one advertisement is often referred to as an ‘impression.’ When an advertising impression is served to a user, the user may activate an embedded or associated hyperlink, and another web page associated with the subject of the advertisement may be displayed. Activating (e.g., clicking on) an advertisement increases the advertisement's ‘click-through rate’ or CTR. Moreover, the user may subsequently register with the entity responsible for the advertisement (e.g., the advertiser) or take another action to indicate that they are interested in the advertisement or the subject of the advertisement (e.g., by completing a survey or subscribing to announcements); this is sometimes referred to as ‘conversion.’

In general, there are more impressions served than resulting clicks, and more clicks than conversions. Fees are typically paid to the provider of the web page for impressions, clicks and/or conversions. However, because the probabilities of occurrence are usually inversely related to the value to the advertiser, the fees paid for conversions are usually larger than for clicks, which in turn are larger than the fees paid for impressions.

In order to maximize the effectiveness of an advertising campaign (and to maximize the return on investment for the fees paid to publishers—the providers of web pages that present the advertising content to their users), the advertisers typically attempt to selectively target the content to users to increase the probabilities of impressions, clicks, and conversions. Providers of other types of content may also wish to reach the most receptive audience. However, it can be difficult to accurately target users. This can be frustrating for the users (because they are often distracted by content that they are not interested in) and can represent a significant expense (in terms of fees paid to the publishers of the web pages) and opportunity cost to the advertisers (in terms of lost sales because of an ineffective advertising campaign).

### BRIEF DESCRIPTION OF THE FIGURES

FIG. 1 is a block diagram illustrating a system that targets users of a social network in accordance with an embodiment of the present disclosure.

FIG. 2 is a drawing illustrating a social graph in accordance with an embodiment of the present disclosure.

FIG. 3 is a flow chart illustrating a method for associating a subset of users of a social network with a target group in accordance with an embodiment of the present disclosure.

FIG. 4 is a flow chart illustrating the method of FIG. 3 in accordance with an embodiment of the present disclosure.

FIG. 5 is a flow chart illustrating a method for associating a subset of users of a social network with an interest segment in accordance with an embodiment of the present disclosure.

FIG. 6 is a flow chart illustrating the method of FIG. 5 in accordance with an embodiment of the present disclosure.

FIG. 7 is a flow chart illustrating a method for selecting rules for targeting types of types of recommendations to users in accordance with an embodiment of the present disclosure.

FIG. 8 is a flow chart illustrating the method of FIG. 7 in accordance with an embodiment of the present disclosure.

FIG. 9 is a block diagram illustrating a computer system that performs the methods of FIGS. 3-8 in accordance with an embodiment of the present disclosure.

FIG. 10 is a block diagram illustrating a data structure for use in the computer system of FIG. 9 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of a system that includes a computer system, a technique for selecting rules for targeting one or more types of content to users of a social network, and a computer-program product (e.g., software) for use with the computer system are described. During this targeting technique, features are extracted from user profiles and from histories of previously served content, and used to measure or estimate the relevancy, to the users, of content available for serving to the users.

More specifically, some of the features used for targeting are associated with attributes in profiles of the users of the social network (which facilitates interactions among the users); others are associated with types of content and/or specific content items previously provided to the users. In some implementations, the recommendations are computed offline, in which case the features may be extracted without immediately providing any recommended content to the users. In other implementations, the recommendations are computed and applied in real-time.

From the extracted features, relevancy scores are determined. The relevancy scores may be based on user behaviors such as online activities, searches, different types of page views, profile views, emails sent, etc. Moreover, one or more of the extracted features are selected as rules for identifying one or more types of content to target to the users.

By identifying the rules (and, thus, the one or more types of content), a targeting technique provided herein may increase the effectiveness of subsequent advertising campaigns. In particular, by restricting or reducing the type of content considered for serving to users, the targeting technique may allow the relevancy of the remaining types of content to be determined in real-time using a machine-learning model (such as a supervised-learning model, a semi-supervised-learning model and/or an un-supervised-learning model), and to be determined with greater accuracy.

Thus, the targeting technique may reduce the cost and latency associated with an advertising campaign (e.g., comprising advertisements), a job hunt (e.g., comprising applications or searches for jobs), recruitment of a new employee (e.g., comprising job recommendations), and/or other types of content, and may improve the relevancy of content that is served. Consequently, the targeting technique may increase the user response in the advertising campaign (e.g., by increasing the CTR), the job hunt (e.g., by obtaining more interview invitations) or the recruitment (e.g., by increasing the number of inquiries), thereby improving the satisfaction of the users and the advertisers, job-seekers, employers and/or other content providers. In different embodiments of the invention, different types of content may therefore be served or recommended to be served, including advertisements, résumés of job seekers, job notifications, and/or others.

In the discussion that follows, an individual or a user may include a person (for example, an existing customer, a new customer, a prospective employer, a prospective employee, a supplier, a service provider, a vendor, a contractor, etc.). More generally, the targeting technique may be used by an organization, a business and/or a government agency. Furthermore, a ‘business’ should be understood to include for-profit corporations, non-profit corporations, groups (or cohorts) of individuals, sole proprietorships, government agencies, partnerships, etc.

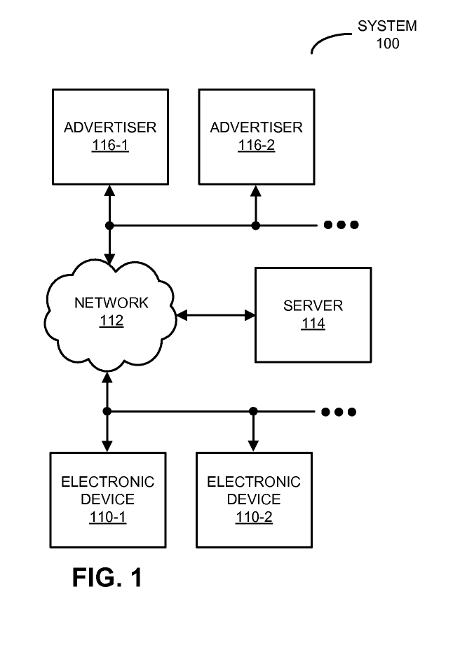

We now describe embodiments of the system and its use. FIG. 1 presents a block diagram illustrating a system 100 that performs a targeting technique. In this system, users of electronic devices 110 may use a software product, such as instances of a software application that is resident on and that executes on electronic devices 110.

Alternatively, the users may interact with a web page that is provided by server 114 via network 112, and which is rendered by web browsers on electronic devices 110. For example, at least a portion of the software application may be an application tool that is embedded in the web page, and which executes in a virtual environment of the web browsers. Thus, the application tool may be provided to the users via a client-server architecture.

The software application operated by the users may be a standalone application or a portion of another application that is resident on and which executes on electronic devices 110 (such as a software application that is provided by server 114 or that is installed and which executes on electronic devices 110).

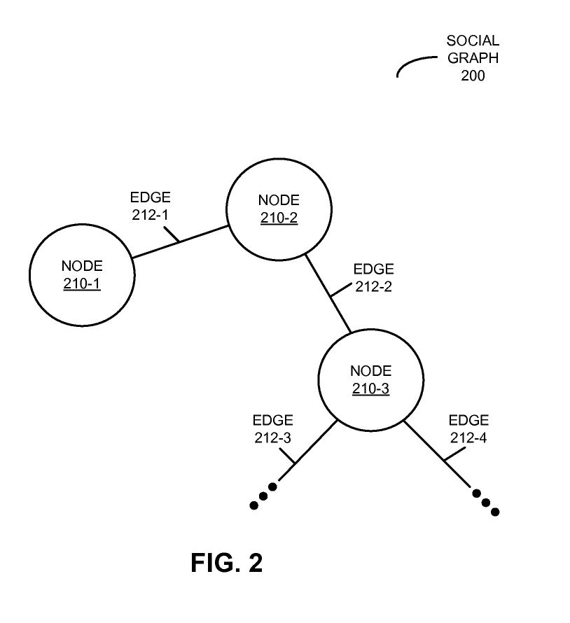

Using one of electronic devices 110 (such as electronic device 110-1) as an illustrative example, a user of electronic device 110-1 may use the software application to interact with other users in a social network that facilitates interactions among the users, such as the creation and maintenance of professional and/or personal relationships. As described further below with reference to FIG. 2, the interactions among the users may specify a social graph in which nodes correspond to the users and edges between the nodes correspond to the interactions. Note that each of the users of the software application may have an associated profile that includes personal and/or professional characteristics and experiences (such as education, employment history, demographic information, work locations, etc.), which are collectively referred to as ‘attributes’ in the discussion that follows.

While the users of electronic devices 110 are using the software application, server 114 may provide content to one or more of electronic devices 110 via network 112. For example, the content may include one or more advertisements (i.e., advertising content) that are displayed on electronic devices 110 (such as in a web page by a browser) for the users to view. These advertisements may be presented to the users in the context of advertising campaigns conducted by advertisers 116. In particular, advertisers 116 may interact with server 114 via network 112 to set or predefine the details of their advertising campaigns (such as targeted groups, budgets, etc.), and server 114 may provide the advertisements based on these predefined details.

In the discussion that follows, ‘advertisements’ generally refer to content served to promote awareness and/or sales of a product or a service. However, in some embodiments, ‘advertisements’ also encompass content related to employment opportunities. Thus, advertisers 116 may also include potential employers. Note that the advertisements presented to the users by server 114 are sometimes referred to as ‘recommendations,’ especially if intended to recommend a job opportunity. Also, the term ‘advertisement’ as used herein may refer to a given advertisement campaign or a discrete advertisement impression within a given campaign.

In response to advertisements served to them, the users of electronic devices 110 may provide feedback in the form of actions taken on the impressions served to them, such as clicks and/or conversions. The mere serving of an impression may also be noted or recorded as feedback (e.g., especially if the advertiser is being charged on a CPM basis).

Server 114 may aggregate this information into feedback metrics for multiple users, and may store this information for subsequent use. In addition, via network 112, server 114 may monitor and store information about user actions or behaviors, such as web pages or Internet Protocol (IP) addresses the users visit, search topics, search frequency, how often a given user checks who viewed their profile in the social network, how often the given user views profiles of other users in the social network, etc.

Alternatively or additionally, while the users of electronic devices 110 are using the software application, the users may share with each other categorical content corresponding to predefined interest segments. For example, via network 112, the user of electronic device 110-1 may communicate that he or she ‘likes’ information about a topic (which, equivalently, is sometimes referred to as a ‘channel,’ a ‘category,’ an ‘interest category’ or an ‘interest segment’) with one of the other users. These ‘likes’ or ‘shares’ may be monitored by server 114 via network 112, and server 114 may aggregate and store this information as content-interaction data for subsequent use. Note that the predefined interest segments may be defined or specified by one or more of the users and/or may be specified by advertisers 116 in the predefined details for their advertising campaigns.

Server 114 may use the stored information about advertising campaigns, employment opportunities and, more generally, the types of content or recommendations, the sharing of content by the users, user profiles and/or user behaviors to train machine-learning models that can be used to predict user responses to future advertising campaigns (and, thus, to place the users into different target groups to facilitate targeted advertising), user interests (and, thus, to identify interest segments that the users may like and/or categorize the users according to those segments), and/or user responses to future content (and, thus, to identify rules that can be used to identify which users may be interested in particular content or types of content, such as specific employment opportunities or particular types of employment).

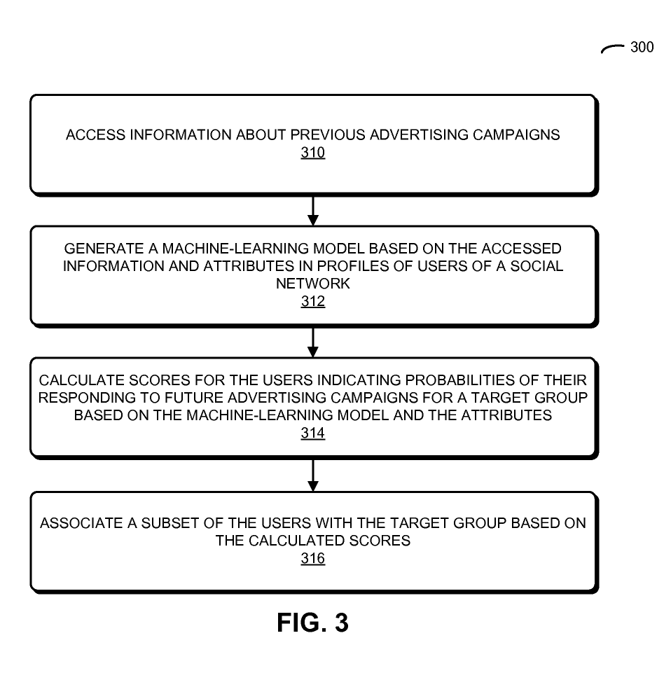

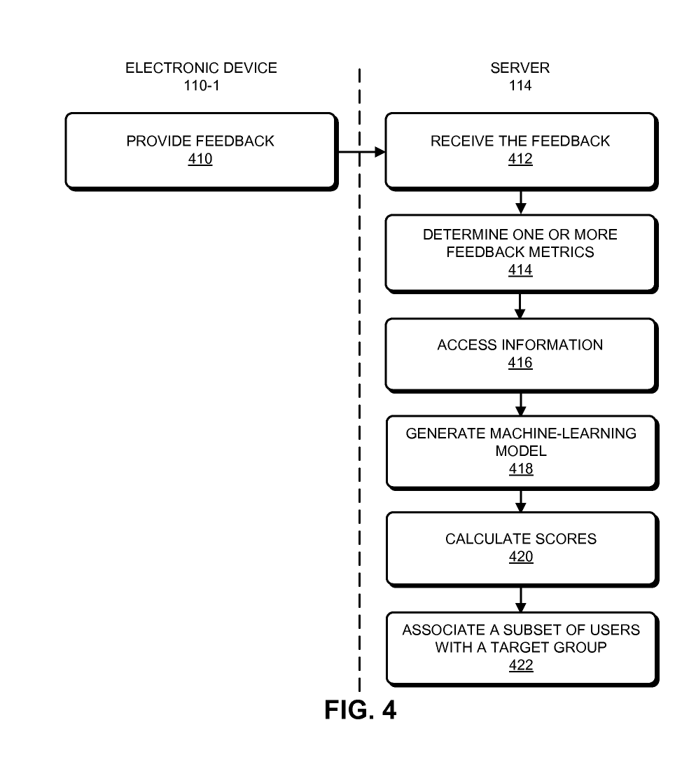

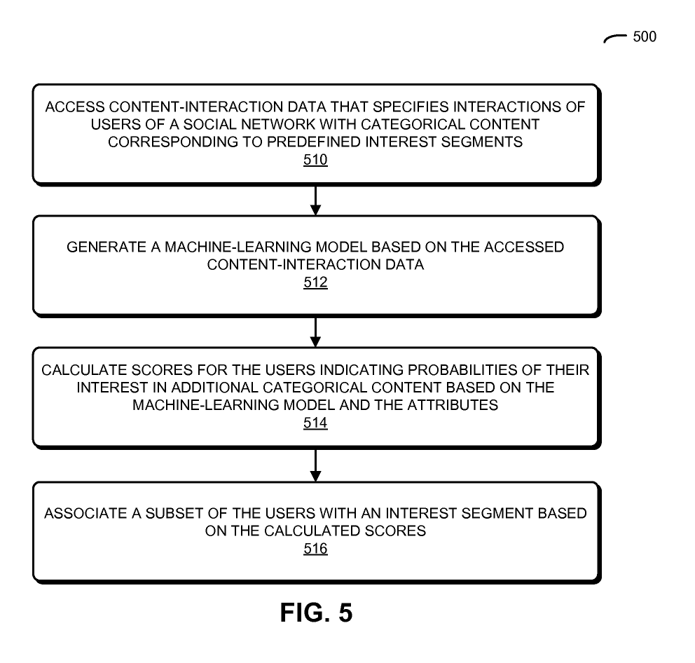

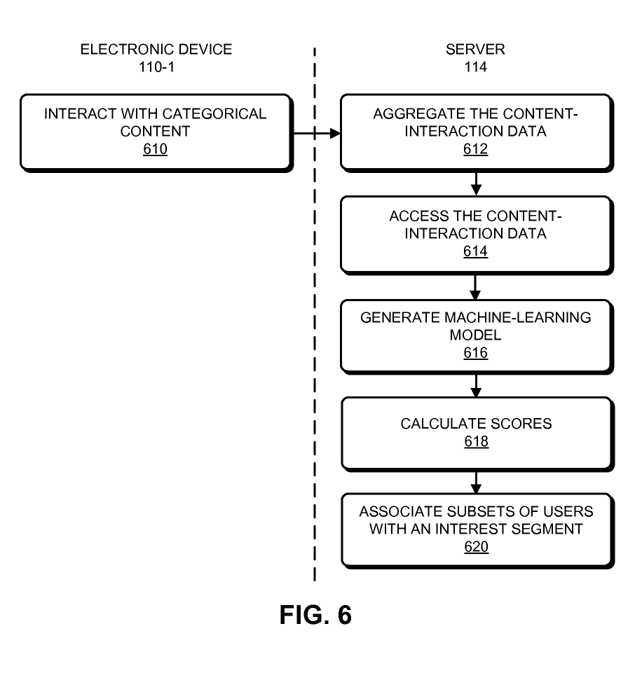

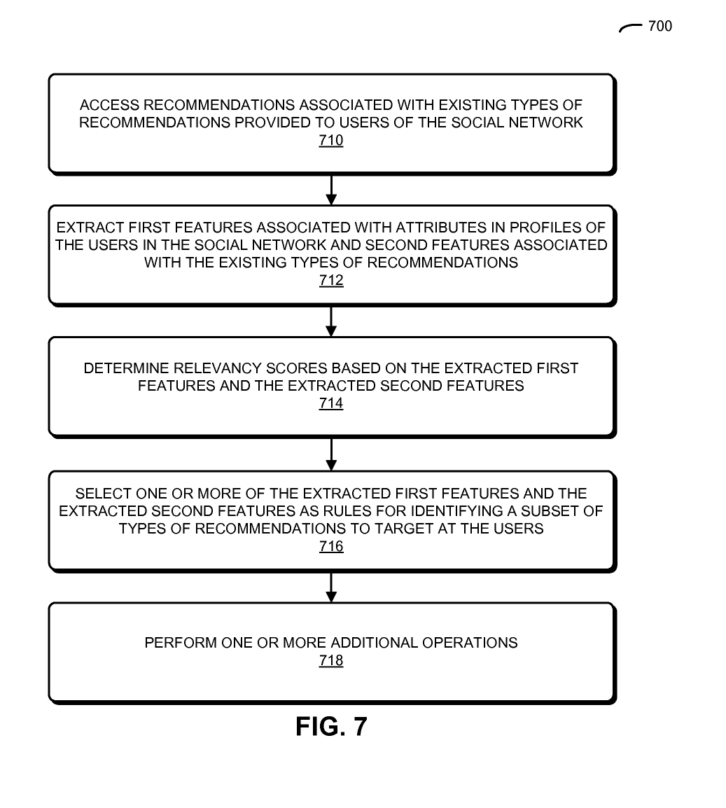

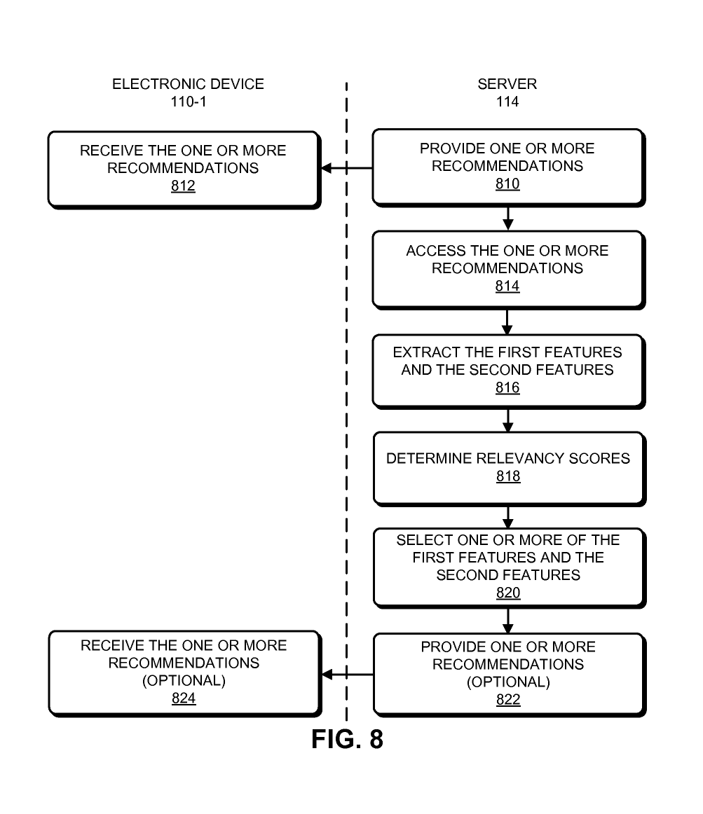

For example, as described below with reference to FIGS. 3 and 4, a machine-learning model may be based on user responses to previous advertising campaigns, and the users' profiles, which may allow a subset of the users to be associated with an advertising target group. Similarly, as described below with reference to FIGS. 5 and 6, a machine-learning model may be based on content-interaction data that specifies viewing and sharing of content by the users, and/or their profiles, which may allow a subset of the users to be associated with a content interest segment. Furthermore, as described below with reference to FIGS. 7 and 8, server 114 may extract features from the user profiles and from content available for serving to users, which may be used as rules to identify a subset of the users to target with particular recommendations regarding employment opportunities and/or other types of content.

By monitoring, aggregating, and storing information about user interactions with advertising, recommendations, content and each other in the social network, server 114 may allow the users and their interests to be better identify and used to match users with available content. This may allow server 114 to offer improved service to the users and advertisers 116, in the form of more accurately targeted advertisements, recommendations and/or interesting content. Consequently, a targeting technique implemented in system 100 may increase both user and advertiser 116 satisfaction and, thus, may increase the revenue and profitability of a provider of the software application.

Note that information in system 100 may be stored at one or more locations in system 100 (i.e., local or remote relative to server 114). Moreover, because this data may be sensitive in nature, it may be encrypted. For example, stored data and/or data communicated via network 110 may be encrypted.

We now further describe profiles of the users. As noted previously, the profile of a user may, at least in part, specify a social graph or a portion of a social graph. FIG. 2 is a drawing illustrating a social graph 200. This social graph may represent the connections or interrelationships among nodes 210 using edges 212. In the context of the targeting technique, one of nodes 210 (such as node 210-1) may correspond to a given user, and the remainder of nodes 210 may correspond to other users (or groups of users) in the social network. Edges 212 may represent interrelationships among these users, such as companies where they worked, schools they attended, organizations (companies, schools, etc.) that the individuals are (or used to be) associated with, etc. Consequently, social graph 200 may be used to determine targets among the users, for example, by counting or tracing edges 212 between current members of an organization and the user.

In general, a given node in social graph 200 may be associated with a wide variety of information that is included in the user profiles, such as, but not limited to, age, gender, geographic location, work industry for a current employer, functional area (e.g., engineering, sales, consulting), seniority in an organization, employer size, schools attended, previous employers, current employer, professional development, interest segments, target groups, additional professional attributes and/or inferred attributes (which may include or be based on user behaviors). Furthermore, user behaviors may include log-in frequencies, search frequencies, search topics, browsing certain web pages, locations (such as IP addresses) associated with the users, advertising or recommendations presented to the users, user responses to the advertising or recommendations, likes or shares exchanged by the users, and/or interest segments for the likes or shares.

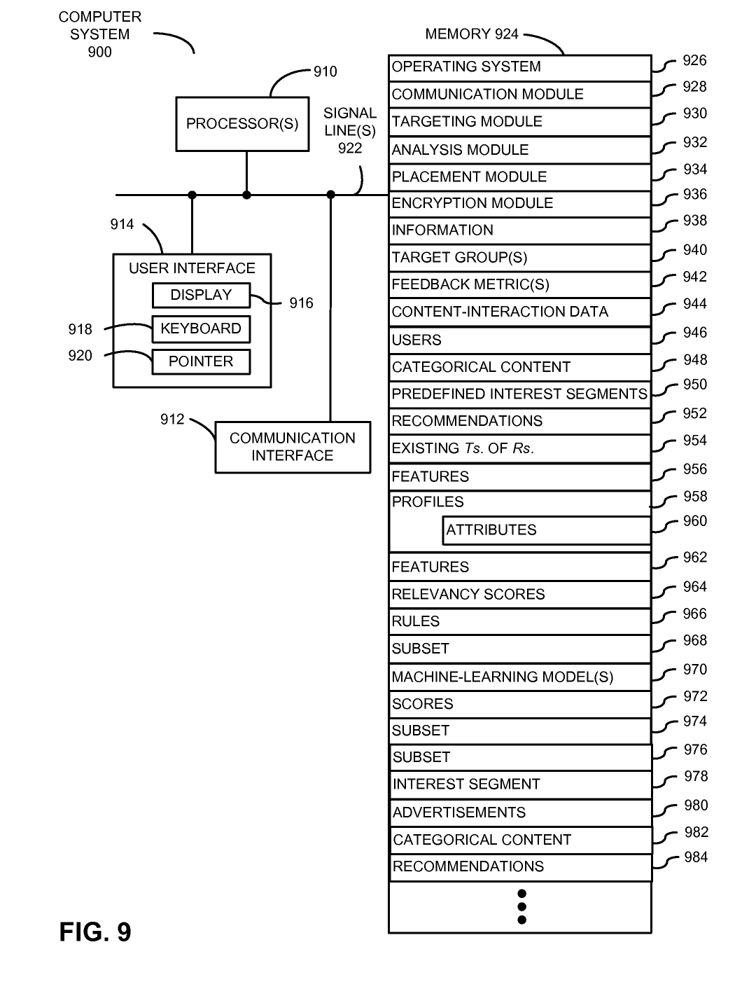

We now describe embodiments of the targeting technique. FIG. 3 presents a flow chart illustrating a method 300 for associating a subset of users of a social network with a target group, which may be performed by a computer system (such as server 114 in FIG. 1 or computer system 900 in FIG. 9). During operation, the computer system accesses information about previous advertising campaigns (operation 310), where the information for a given previous advertising campaign specifies a target group and one or more associated feedback metrics obtained from individuals. For example, the information may be stored in a computer-readable memory in system 100 (FIG. 1).

In some implementations, the one or more associated feedback metrics may include a number of views of advertisements associated with the given previous advertising campaign (i.e., a number of impressions served) and/or identities of the impressions, a number of clicks on the advertisement impressions associated with the given previous advertising campaign (and/or the resulting click-through rate), and/or a number of completed transactions after clicking on the advertisement impressions associated with the given previous advertising campaign (e.g., a number of conversions, the corresponding conversion rate). In some embodiments, the number of impressions is based on how often the users log in to the social network.

Then, the computer system generates a machine-learning model based on the accessed information and attributes in profiles of the users of the social network (operation 312). For example, if the target group is ‘business travelers,’ the attributes for a given user may include a frequency of searches conducted by the given user, how often the given user checks who viewed their profile in the social network, and/or how often the given user views profiles of other users in the social network. In addition, the attributes for the given user may include a number of IP addresses associated with different geographic locations for the given user within a time interval. These factors may more accurately predict whether a given user is likely to be a business traveler.

Moreover, the computer system calculates scores for the users indicating probabilities of their responding to a future advertising campaign for the target group based on the machine-learning model and the attributes (operation 314).

Next, the computer system associates the subset of the users with the target group based on the calculated scores (operation 316). For example, associating the subset of the users with the target group may involve ranking the users based on the calculated scores, such as 5-10 million users having the top scores. Thus, method 300 may be used to identify a ‘fingerprint’ of the target group, which can be used to select the subset and to conduct a future advertising campaign.

In an exemplary embodiment, the targeting technique is implemented using one or more electronic devices and at least one server, which communicate through a network, such as a cellular-telephone network and/or the Internet (e.g., using a client-server architecture). This is illustrated in FIG. 4, which presents a flow chart illustrating method 300 (FIG. 3). During this method, a user of one of electronic devices 110 in FIG. 1 (such as electronic device 110-1) provides feedback (operation 410) in response to an advertising campaign that targeted the user (i.e., the user is in a target group selected for the advertising campaign). Server 114 receives the feedback (operation 412). Then, server 114 determines the one or more feedback metrics (operation 414) based on the feedback received from electronic device 110-1 (as well as from the users of other electronic devices 110 in FIG. 1).

Subsequently, server 114 accesses the information (operation 416) associated with the advertising campaign (as well as from other previous advertising campaigns). Moreover, server 114 generates the machine-learning model (operation 418) based on the accessed information and the attributes (which may include user behaviors) in the profiles of the users of the social network.

Furthermore, server 114 calculates scores (operation 420) for the users indicating probabilities of their responding to a future advertising campaign for the target group based on the machine-learning model and the attributes. Next, server 114 associates the subset of the users with the target group (operation 422) based on the calculated scores.

In an exemplary embodiment, the targeting technique is used to assist advertisers. In particular, advertisers want to target audiences who would be more likely to respond to or act upon their advertisements. Often the targeted audience is created using demographic and/or geographic attributes that are determined based on marketing intuition. However, by using audience feedback (e.g., clicks on advertisements and/or conversions), one or more machine-learning models (which are sometimes referred to as ‘propensity models’) can be generated to identify high-quality audience segments that perform well for advertising campaigns in a particular category (i.e., to provide improved performance), and/or build larger audiences from smaller audience segments (i.e., to create so-called ‘reach’ for advertisers).

Thus, the targeting technique may be used to optimize advertising campaigns (as measured, for example, by the click-through rate or CTR, which is defined as the ratio of the number of clicks on an advertisement to impressions of that advertisement that have been served) by leveraging past advertising-campaign data (which is sometimes referred to as ‘look-alike modeling,’ ‘performance-alike modeling,’ and/or ‘behavioral targeting,’ ‘because users’ advertising feedback and other online activities are used to train the machine-learning models).

A targeting technique provided herein may also, or instead, provide a unified framework for identifying customized user segments for a particular target group or interest category (e.g., ‘credit cards’ or ‘finance’) and/or for a specific advertiser (e.g., AmEx). This framework may include a data pipeline to aggregate information about user behavioral profiles in an incremental fashion (such as daily). In particular, because the users' actions are dynamic, their online activities or behaviors may be good indicators of their interests and intents.

However, frequently processing raw tracking and database data can be prohibitively expensive. Consequently, user activities may be aggregated into a single user behavioral profile in an incremental fashion. This behavioral information may include, for example, views of web pages in the social network, searches, emails within the social network, invitations to establish connections with other users of the social network, views of news about other users and/or organizations in the social network, sharing or likes of interesting content (such as articles) communicated to other users in the social network, and/or IP addresses associated with users' locations, etc. In addition, user-profile information may be aggregated, such as titles, company affiliations, industry, function area, gender, and/or seniority.

The framework for identifying customized user segments may also include a modeling pipeline to construct the machine-learning models that optimize advertising-campaign performance and/or reach. For example, information about previous advertising campaigns in a given category (such as one derived from a demand-driven taxonomy, e.g., finance/credit cards, travel/hotel, education/master's degree, etc.) and the user profiles may be used to label ‘positive’ and ‘negative’ users (i.e., those that did or did not respond to a given advertisement).

Then, the aggregated information is used to provide behavioral and profile features that can be leveraged to train a predictive machine-learning model to optimize CTR, conversion and/or reach. For example, for a given category of interest, a machine-learning model can be trained to provide a propensity score for each user based on the attributes in their user profile and their past activities or behaviors in the social network, and/or those of similar users. The propensity score may indicate the likelihood of a response by this user to a future advertisement in the category. The response could be a click and/or conversion (e.g., a product purchase, an account sign-up, etc.). For example, a machine-learning model for a ‘business traveler’ may be determined using information about a group of previous advertising campaigns targeting business travelers. Similarly, a machine-learning model for ‘finance/credit card’ may be determined using information about a group of previous advertising campaigns related to credit cards (e.g., campaigns run by a bank).

Using the calculated propensity scores, qualified users (i.e., the subset associated with the target group) can be identified for subsequent advertising servicing (see FIGS. 5 and 6).

While machine-learning models for a particular category or target group have been used as an illustration, in other embodiments a machine-learning model may be developed for a particular advertiser and/or a particular company or group. For example, in the case of a machine-learning model for a particular advertiser, the machine-learning model may be trained using previous advertising campaigns associated with that advertiser. The intent may be to facilitate advertising-campaign optimization (such as to identify dominant user attributes that lead to clicks/conversions, so that existing targeting criteria can be refined) and/or reach expansion (such as building a larger audience from one or more smaller audience segment(s) to create reach for the particular advertiser). Thus, in these embodiments, the subset identified may only be used for subsequent targeting by the particular advertiser.

Similarly, in the case of a machine-learning model for a particular company or group, the intent may be to facilitate advertising-campaign optimization and/or reach expansion for advertising campaigns targeting a subset of the users who are potentially interested in the particular company or group.

In some embodiments, rather than building a machine-learning model to optimize CTR or conversion rate, the machine-learning model may identify the subset of users in a target group that is similar to the existing valued customers of the particular or given advertiser. For example, the similarity between users may be determined from the attributes in their user profiles (e.g., title, company, industry, seniority, geographic locations), and this may allow user-profile similarity-based look-alike targeting.

Using the target group or category of ‘business traveler’ as an illustrative example (where the associated advertisers may be airlines, hotels, credit-card companies, etc.), advertising impressions and clicks may be aggregated daily or with some other period over some length of time (e.g., one month, two years). As a monthly average, for example, there may have been 7 million impressions served to 1.3 million viewers, with 4,500 clicks received. A representative subset of this data for one or more months may be further split into a training set (e.g., 70% of the data) and a test set (e.g., 30% of the data).

Multiple behavioral and user-profile features (such as 124 different features) may be used to train a machine-learning model (including the time windows when users are more likely to view and/or accept advertising). For example, the machine-learning model may include a logistic regression model, a boosting tree, and/or a support vector machine. However, a wide variety of supervised-learning techniques may be used in the targeting technique. In an exemplary embodiment, the machine-learning model includes a logistic regression model with receiver operating characteristics for the test and the training data each around 0.72. In particular, the logistic regression model may use L2-regularized logistic regression, i.e.,

$$\frac{1}{2} {ω}^{T} \cdot ω + C \cdot {\sum }_{i = 1}^{l} log ( 1 + {e}^{- {y}_{i} \cdot {ω}^{T} \cdot {x}_{i}} ) ,$$

in which the function is minimized as a function of ω. In this regression, x and y are coordinates of a vector, T is the transpose operation, and C and ω are fit parameters. The machine-learning model may include features such as: viewing profiles of other users (with a probability/weight of 0.225), searching the profiles of the other users (with a probability/weight of 0.75), and searching to see who viewed their profiles (with a probability/weight of 0.15).

Using the machine-learning model, the users of the social network are assigned scores based on their user-profile and previous behavioral features. Then, the users are rank-ordered based on their scores, and the computer system selects a threshold to identify the subset that is likely to respond to future advertisements (such as display ads, emails, direct marketing, etc.) in the target group or category. Compared with the baseline (without using the targeting technique), the identified subset may have a 23.37% increase in CTR and a 31.06% increase in reach. Thus, the targeting technique allows the identification of high-quality users (i.e., those with a high CTR) and a large number of impressions (i.e., high reach).

In addition to subsequent targeted advertising, the machine-learning model(s) and/or the identified subsets for one or more target groups or categories may be used to facilitate tiered pricing of advertising. For example, the subset may be subdivided across the dimensions of tiers and interest categories, which are described further below with reference to FIGS. 5 and 6. (More generally, the subset may be subdivided into multiple segments with different pricing strategies.) In this way, two layers of performance may be created (i.e., an expensive and a less-expensive audience), which then may be further subdivided based on categorical taxonomies.

FIG. 5 presents a flow chart illustrating a method 500 for associating a subset of users of a social network with an interest segment, which may be performed by a computer system (such as server 114 in FIG. 1 or computer system 900 in FIG. 9). During operation, the computer system accesses content-interaction data that specifies interactions of the users of the social network with categorical content (such as articles, blogs, audio, video, etc.) corresponding to predefined interest segments (operation 510), where the content-interaction data includes viewing of the categorical content and possible sharing of the categorical content with other users of the social network, and where the social network facilitates interactions among the users.

The content-interaction data may be stored in a computer-readable memory in system 100 (FIG. 1) and, for a given user, may include a number of views of the categorical content and/or a number of instances of sharing the categorical content with other users of the social network (such as sharing so-called ‘likes’ with the other users). More generally, content-interaction data may include a variety of social actions, including likes, comments, clicks, unlikes, and following developments associated with another users, as well as content interactions derived from a network update stream that includes updates associated with a user of a social network. Moreover, the users may specify the predefined interest segments. Alternatively or additionally, the predefined interest segments may be associated with previous advertising campaigns (e.g., the predefined interest segments may be specified by the advertisers).

The computer system then generates a machine-learning model based on the accessed content-interaction data (operation 512). The machine-learning model may be based on attributes in profiles of the users and/or behaviors of the users. For example, the attributes may include seniority, title, functional area, and so on, and the behaviors may include sharing or likes that are communicated to other users in the social network.

Moreover, the computer system calculates scores for the users indicating probabilities of their interest in additional categorical content based on the machine-learning model and the attributes (operation 514).

Next, the computer system associates the subset of the users with the interest segment based on the calculated scores (operation 516). For example, associating a subset of the users with the interest segment may involve ranking the users based on the calculated scores and the numbers of users having the scores. This may ensure that the subset includes both users that are likely to be interested in the interest segment and a large enough number of users to provide a desired benefit (i.e., performance and reach).

In an exemplary embodiment, the targeting technique is implemented using one or more electronic devices and at least one server, which communicate through a network, such as a cellular-telephone network and/or the Internet (e.g., using a client-server architecture). This is illustrated in FIG. 6, which presents a flow chart illustrating method 500 (FIG. 5). During this method, a user of one of electronic devices 110 in FIG. 1 (such as electronic device 110-1) interacts with the categorical content (operation 610). Server 114 aggregates the content-interaction data (operation 612) that specifies these interactions (as well as those of users of other electronic devices 110 in FIG. 1).

Subsequently, server 114 accesses the content-interaction data (operation 614). Moreover, server 114 may generate the machine-learning model (operation 616) based on the accessed content-interaction data.

Then, server 114 calculates scores (operation 618) for the users indicating the probabilities of their interest in the additional categorical content based on the machine-learning model and the attributes (which may include user behaviors).

Next, server 114 associates the subset of the users with the interest segment (operation 620) based on the calculated scores.

In an exemplary embodiment, the targeting technique is used to assist advertisers. In particular, the targeting technique may allow advertisers to target audiences based on their interests in categorical content (such as articles about a particular topic). Thus, by leveraging users' content-consumption activities, their interests can be inferred (e.g., finance, education, big data, etc.). The inferred interest may then be used by advertisers to show relevant sponsored-content advertising to the users.

In contrast with method 300 (FIG. 3), in method 500 (FIG. 5) the machine-learning model is based on content-interaction data as opposed to information for a given previous advertising campaign. However, once again, the machine-learning model can be used to optimize the performance (such as the CTR or the conversion rate) and/or the reach of future advertising campaigns for a particular interest category or interest segment. For example, by leveraging content-interaction data (such as comments, likes and/or shares) of articles in the ‘finance and banking’ interest segment, a machine-learning model can be constructed to identify a subset of users that are likely to be interested in ‘finance and banking.’ Subsequently, advertisers can target the identified subset with sponsored content in the same interest segment.

Note that the machine-learning model may extract useful information from those users that commented, liked and/or shared articles in a particular interest segment, such as finance or travel. This information is then used to infer the interests of other users regardless of whether they recently commented, liked and/or shared articles in this particular interest segment. Therefore, the targeting technique may not be limited to the actual volume of users who commented, liked and/or shared articles.

The identified interest segments can be viewed as additional attributes in the profiles of the users. Consequently, in some embodiments the identified interest segments may be used to facilitate user-profile similarity-based look-alike modeling. While this approach may not explicitly optimize performance, it may be used to identify similar users based on the attributes in their user profiles.

In general, in method 500 (FIG. 5), the categorical content may be other than advertising. Moreover, the interest segment may include leadership, management, education, accounting, law, politics, sales, technology, employee happiness, career development, finance, big data, social media, travel, etc. Note that a given interest segment may encompass or be associated with multiple tags (e.g., noun-phrase keywords).

As described previously for method 300 (FIG. 3), the subset of the users identified using method 500 (FIG. 5) may be further subdivided (e.g., based on interests or other inferred attributes) to facilitate different pricing strategies for different tiers.

FIG. 7 presents a flow chart illustrating a method 700 for selecting rules for targeting users with different types of content, which may be performed by a computer system (such as server 114 in FIG. 1 or computer system 900 in FIG. 9). During operation, the computer system accesses recommendations associated with one or more types of recommendations (e.g., job recommendations) provided to users of a social network (operation 710). The information may be stored in a computer-readable memory in system 100 (FIG. 1). Note that employment opportunities may be paid or unpaid, and permanent or temporary.

Although embodiments of the invention are described as they are implemented to select a specific recommendation to serve to a user, from one of multiple types of recommendations (e.g., employment opportunities, a relationship with another user), other embodiments may be implemented to select specific content items of other types (e.g., advertising, audio, video, multi-media content).

Then, the computer system extracts first features associated with attributes in profiles of the users in the social network and second features associated with the existing types of recommendations (operation 712).

Moreover, the computer system determines relevancy scores based on the extracted first features and the extracted second features (operation 714). For example, the relevancy scores may be determined using a Jaccard similarity (i.e., the size of the intersection divided by the size of the union of a given first set of features and a given second set of features), mutual information, a Bayesian probability, and/or a co-occurrence relationship. However, a wide variety of statistical-association metrics may be used.

Furthermore, the computer system selects one or more of the extracted first features and one or more of the extracted second features to use as rules for identifying a subset of types of recommendations that may be targeted at the users (operation 716). Note that the subset of the types of recommendations may be selected based on a number of the types of recommendations having the one or more of the extracted second features and a number of users having one or more of the extracted first features. This may ensure that the subset of the types of recommendations includes types of recommendations that are likely to be of interest to the users and a large enough number of types of recommendations (i.e., to promote performance and reach).

In some embodiments, the computer system optionally performs one or more additional operations (operation 718). For example, the computer system may generate a machine-learning model that outputs probabilities that the users are interested in a given type of recommendation based on one or more of the extracted first features and one or more of the extracted second features. Moreover, the computer system may optionally calculate scores that indicate the probabilities that the users are interested in the given type of recommendation based on the machine-learning model and the attributes in the profiles of the users. Additionally, the computer system may optionally provide recommendations associated with the given type of recommendation to at least some of the users based on the calculated scores.

In an exemplary embodiment, the targeting technique is implemented using one or more electronic devices and at least one server, which communicate through a network, such as a cellular-telephone network and/or the Internet (e.g., using a client-server architecture). This is illustrated in FIG. 8, which presents a flow chart illustrating method 700 (FIG. 7). During this method, server 114 provides one or more recommendations (operation 810) associated with, or that include, one or more types of recommendations to users of electronic devices 110 in FIG. 1 (such as electronic device 110-1). Electronic device 110-1 receives the one or more recommendations (operation 812).

Subsequently, server 114 accesses the one or more recommendations (operation 814). Then, server 114 extracts the first features and the second features (operation 816).

Moreover, server 114 determines relevancy scores (operation 818) based on the extracted first features and the extracted second features.

Next, server 114 selects one or more of the first features and one or more of the second features (operation 820) as rules for identifying the subset of the types of recommendations.

In some embodiments, server 114 optionally provides one or more recommendations (operation 822) associated with the given type of recommendation to at least some of the users based on the calculated scores. For example, if the specified type of recommendation is ‘employment opportunity,’ the one or more recommendations may include specific job opportunities that have been made known via the social network.

Electronic device 110-1 may optionally receive (operation 824) one or more of these recommendations. Note that optionally providing the one or more recommendations (operation 822) may involve generating the machine-learning model that outputs the probabilities that the users are interested in a given type of recommendation in the subset of the types of recommendations based on one or more of the extracted first features and one or more of the extracted second features, and calculating the scores that indicate the probabilities that the users are interested in the given type of recommendation based on the machine-learning model and the attributes in the profiles of the users (which may include user behaviors).

In an exemplary embodiment, the targeting technique is used to assist the providers of sponsored jobs or employment opportunities. However, the targeting technique may be used in conjunction with other recommendation types, such as advertisements, news, connections, etc. For example, in the social network, sponsored employment opportunities can be targeted to various user groups based on attributes in their user profiles and/or their behaviors when using or interacting with each other in the social network. More specifically, advertisers (such as prospective employers) can choose to target users with specific profile/behavioral attributes such as functional areas, seniority levels, locations, frequency of visit, etc. For a given user, the targeting restrictions may be applied first, and then the qualified candidate employment opportunities may be scored using machine-learning models to identify the best recommendations for the users.

However, advertisers often do not specify strict targeting rules, because they do not want to restrict their reach. This may result in a large set of candidate employment opportunities for a given user and, therefore, real-time scoring may become infeasible. By using the targeting technique, the number of candidate employment opportunities may be reduced. This may allow the remaining candidate employment opportunities to be efficiently and cost-effectively scored using a machine-learning model (otherwise there may be too many candidate employment opportunities), so that the subset can be identified. This, in turn, allows recommendations for candidate employment opportunities to be targeted to the users.

The approach used in a classification technique is to identify predictive-filtering rules and to use them to reduce the number of candidate employment opportunities for a given user. This approach may balance competing objectives, including reducing the number of candidate employment opportunities to acceptable levels (otherwise the number of candidate employment opportunities may be unwieldy and expensive to process, e.g., there may be significant overhead and latency), and/or not dropping good candidates (i.e., those that are, in fact, relevant or of interest to the given user). Otherwise, the pool of candidate employment opportunities may be too small and/or the relevancy of the future recommendations may be reduced.

The predictive filtering rules may be learned from previous recommendations in historical tracking data. Alternatively, the predictive filtering rules may be learned from offline simulations in which the recommendations are computed using a machine-learning model that is deployed or which was created for this purpose. For example, job-feature and user-attribute co-occurrences (such as the user's or job's country, functional area, seniority, etc.) may be determined in a large set of recommendations using various techniques, such as Jaccard similarity and mutual information.

Then, these extracted rules may be used to filter out candidate employment opportunities that are most likely to be irrelevant to the given user, and the remaining candidate employment opportunities may be scored using a machine-learning model to determine the best matches. For example, for a given user, candidate employment opportunities having job features that never (or almost never) occurred in the previous recommendations may be safely excluded.

In an exemplary embodiment, many of the previous recommendations for jobs or employment opportunities in the function area ‘engineering’ may have been delivered to users in ‘information technology,’ ‘entrepreneurship,’ ‘consulting,’ ‘engineering,’ etc., but not to users in ‘accounting,’ ‘sales,’ etc. Therefore, for a user in ‘engineering,’ candidate employment opportunities in ‘accounting,’ ‘sales,’ etc. may be safely excluded. Furthermore, in some embodiments, the rules are extracted based on user interaction or responses to the previous recommendations (as opposed to solely on the job features associated with the recommendations), such as a number of impressions, a number of clicks (or click-through rate) and/or a number of conversions (or conversion rate).

The predictive filtering may enable scaling of the recommendations to large inventories of candidate employment opportunities. Furthermore, because the targeting technique learns the predictive filtering rules from existing recommendations, it can easily be adapted to other recommendation techniques in domains where the number of candidate content items is large (such as movies, news articles, etc.).

As noted previously, a predictive filtering technique balances the need to filter a (potentially large) set of bad candidates, while ensuring that no good candidates are dropped. The targeting technique may compute metrics to assess these competing objectives. One metric is the ratio of the preserved recommendations at the top K recommendations (which is sometimes referred to as the ‘overlap at the top K’ or ‘rOverlap@K’).

This metric may be determined by applying the extracted filtering rules to the top K recommendations to identify the set of types of recommendations (F) that are filtered out. Thus, rOverlap@K equals

$$\frac{K - F}{K} ,$$

which ideally is close to 1.0 for a given user.

In addition, another metric is the filtering ratio (fRatio), which measures the reduction rate in the set of candidate types of recommendations (which, ideally, is as small as possible). For a randomly selected set of candidate types of recommendations M (around 2,000-3,000 candidate types of recommendations), fRatio may be determined by finding the number of candidate types of recommendations qualified after the extracted rules are applied. This ratio may then be compared to the baseline (note that the worst case result is M·J, where there is no filtering and all the candidate types of recommendations remain for each user (represented by J).

In an exemplary embodiment, for a particular type of recommendation (such as an employment opportunity for a senior or direct-level job), the Jaccard similarity (i.e., the intersection of A and B over the union of A and B), the mutual information

$$\frac{{P}_{x , y}}{{P}_{x} \cdot {P}_{y}}$$

(where Pᵢ is the probability of i), and/or the co-occurrence (the intersection of A and B over B) is 5% or larger for user profiles of managers. Based on this analysis, the rule for this candidate type of recommendation may be that ‘no entry level’ users are applicable. In this case, rOverlap@25 may be 88.18% and fRatio may be 57.5%.

In some embodiments of methods 300 (FIGS. 3 and 4), 500 (FIGS. 5 and 6) and/or 700 (FIGS. 7 and 8), there may be additional or fewer operations. For example, advertisements may be targeted to the users in the subset based on the association with the interest segment and/or the target group. Moreover, the order of the operations may be changed, and/or two or more operations may be combined into a single operation.

Note that methods 300 (FIGS. 3 and 4), 500 (FIGS. 5 and 6) and/or 700 (FIGS. 7 and 8) may be offered by a third party (e.g., another organization) as a paid service to an advertiser (e.g., a company or organization). Therefore, the operations in methods 300 (FIGS. 3 and 4), 500 (FIGS. 5 and 6) and/or 700 (FIGS. 7 and 8) may be performed by the other organization. However, in other embodiments representatives of the advertiser perform the operations in methods 300 (FIGS. 3 and 4), 500 (FIGS. 5 and 6) and/or 700 (FIGS. 7 and 8).

We now describe embodiments of a computer system for performing a method described herein, and its use. FIG. 9 presents a block diagram illustrating a computer system 900 that performs methods 300 (FIG. 3), 500 (FIG. 5), and/or 700 (FIG. 7). Computer system 900 includes one or more processing units or processors 910, a communication interface 912, a user interface 914, and one or more signal lines 922 coupling these components together. Note that the one or more processors 910 may support parallel processing and/or multi-threaded operation, the communication interface 912 may have a persistent communication connection, and the one or more signal lines 922 may constitute a communication bus. Moreover, the user interface 914 may include a display 916 (such as a touchscreen), a keyboard 918, and/or a pointer 920 (such as a mouse).

Memory 924 in computer system 900 may include volatile memory and/or non-volatile memory. More specifically, memory 924 may include ROM, RAM, EPROM, EEPROM, flash memory, one or more smart cards, one or more magnetic disc storage devices, and/or one or more optical storage devices. Memory 924 may store an operating system 926 that includes procedures (or a set of instructions) for handling various basic system services for performing hardware-dependent tasks. Memory 924 may also store procedures (or a set of instructions) in a communication module 928. These communication procedures may be used for communicating with one or more computers and/or servers, including computers and/or servers that are remotely located with respect to computer system 900.

Memory 924 may also include multiple program modules (or sets of instructions), including targeting module 930 (or a set of instructions), analysis module 932 (or a set of instructions), placement module 934 (or a set of instructions) and/or encryption module 936 (or a set of instructions). Note that one or more of these program modules (or sets of instructions) may constitute a computer-program mechanism.

During operation of computer system 900, targeting module 930 may receive information 938 via communication interface 912 and communication module 928, and may store information 938 in memory 924. For example, information 938 may be about previous advertising campaigns, such as one or more target groups 940 and one or more associated feedback metrics 942 obtained from individuals (such as number and/or identities of impressions, a number of clicks, a number of conversions and/or a log-in frequency). Targeting module 930 may have aggregated information 938 while placement module 934 conducted the previous advertising campaigns.

Alternatively, information 938 may include content-interaction data 944 that specifies interactions of users 946 of a social network with categorical content 948 corresponding to predefined interest segments 950. Moreover, content-interaction data 944 may include a number of views of categorical content 948 and a number of shares of categorical content 948 with other users of the social network.

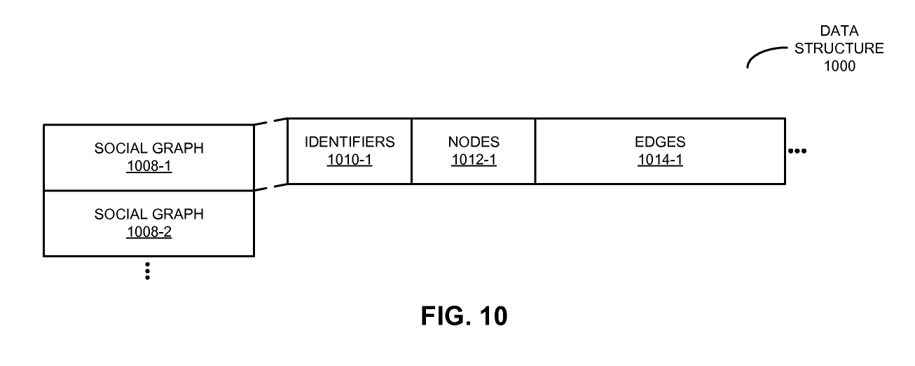

In some embodiments, information 938 may include recommendations 952 associated with existing types of recommendations 954 (which may be abbreviated as Ts of Rs) provided to users 946 of the social network. In these embodiments, targeting module 930 extracts features 956 associated with attributes 960 in profiles 958 of users 946 in the social network (which are described further below with reference to FIG. 10) and features 962 associated with existing types of recommendations 954. Then, analysis module 932 may determine relevancy scores 964 based on features 956 and features 962. Moreover, targeting module 930 may select one or more of features 956 and features 962 as rules 966 for identifying a subset 968 of types of recommendations that may be targeted at or to users 946.

Then, analysis module 932 may generate one or more machine-learning models 970 based on information 938 and attributes 960 in profiles 958 of users 946 of the social network. For example, analysis module 932 may use training and testing subsets of information 938 and attributes 960 to generate the one or more machine-learning models 970. Depending on information 938 that is used, different machine-learning models may be generated. Thus, in the case of the previous advertising campaigns, a machine-learning model for a particular one of target groups 940 may relate attributes 960 and/or user behaviors to the one or more associated feedback metrics 942. Alternatively, in the case of interactions of users 946 of the social network with categorical content 948, a machine-learning model for a particular one of predefined interest segments 950 may relate attributes 960 and/or user behaviors to content-interaction data 944. Similarly, in the case of recommendations 952 associated with existing types of recommendations 954, a machine-learning model for a particular type of recommendation (such as one associated with a job or a particular employer) may optionally relate features 956 and/or features 962, as well as attributes 960 and/or user behaviors, to a probability that users 946 are interested in a given type of recommendation in subset 968 of the types of recommendations.

In general, profiles 958 may include characteristics of the users and/or behaviors of the users when using the social network. Moreover, profiles 958 may include information specified directly by the users and/or information inferred (i.e., gathered indirectly) about the users (which are sometimes referred to as ‘inferred attributes’).

As noted previously, profiles 958 may be included in a social graph that specifies the interactions and/or relationships among users 946. This is shown in FIG. 10, which presents a block diagram illustrating a data structure 1000 with one or more social graphs 1008 for use in computer system 900 (FIG. 9). In particular, social graph 1008-1 may include identifiers 1010-1 for users 946 in FIG. 9, nodes 1012-1 (for associated attributes 960 in FIG. 9), and/or edges 1014-1 that represent relationships or connections between nodes 1012-1. For example, nodes 1012-1 may include skills, jobs, companies, schools, locations, etc. Thus, nodes 1012-1 may indicate interrelationships among users 946 (FIG. 9) in the social network, as indicated by edges 1014-1, and therefore one or more of social graphs 1008 may be used to identify subsets of users 946 (FIG. 9).

Referring back to FIG. 9, using one or more of machine-learning models 970, attributes 960 and/or user behaviors, targeting module 930 may calculate scores 972 for users 946. In the case of the previous advertising campaigns, scores 972 may indicate probabilities of users 946 responding to a future advertising campaign for one of target groups 940. Moreover, targeting module 930 associates a subset 974 of users 946 with the one of the target groups 940 based on scores 972.

Alternatively, in the case of predefined interest segments 950, scores 972 for users 946 may indicate probabilities of their interest in additional categorical content 982 (which is other than categorical content 948). Moreover, targeting module 930 associates a subset 976 of users 946 with an interest segment 978 based on scores 972.

In embodiments for recommendations 952 associated with existing types of recommendations 954, scores 972 may optionally indicate probabilities that users 946 are interested in the given type of recommendation.

Subsequently, placement module 934 may use the calculated information to provide advertising, content or recommendations to users 946. For example, placement module 934 may target advertisements 980 in a new advertising campaign at one or more of users 946 in subset 974. Alternatively, placement module 934 may provide categorical content 982 to subset 976 of users 946 with interest segment 978. In some embodiments, placement module 934 may optionally provide recommendations 984 associated with the given type of recommendation in subset 968 of the types of recommendations to at least some of users 946 based on scores 972. Note that advertisements 980, categorical content 982 and/or recommendations 984 may be provided to the one or more of users 946 via communication module 928 and communication interface 912.

Because information in computer system 900 may be sensitive in nature, in some embodiments at least some of the data stored in memory 924 and/or at least some of the data communicated using communication module 928 is encrypted using encryption module 936.

Instructions in the various modules in memory 924 may be implemented in: a high-level procedural language, an object-oriented programming language, and/or in an assembly or machine language. Note that the programming language may be compiled or interpreted, e.g., configurable or configured, to be executed by the one or more processors.

Although computer system 900 is illustrated as having a number of discrete items, FIG. 9 is intended to be a functional description of the various features that may be present in computer system 900 rather than a structural schematic of the embodiments described herein. In practice, and as recognized by those of ordinary skill in the art, the functions of computer system 900 may be distributed over a large number of servers or computers, with various groups of the servers or computers performing particular subsets of the functions. In some embodiments, some or all of the functionality of computer system 900 is implemented in one or more application-specific integrated circuits (ASICs) and/or one or more digital signal processors (DSPs).

Computer systems (such as computer system 900), as well as computers and servers in system 100 (FIG. 1), may include one of a variety of devices capable of manipulating computer-readable data or communicating such data between two or more computing systems over a network, including: a personal computer, a laptop computer, a tablet computer, a mainframe computer, a portable electronic device (such as a cellular phone or PDA), a server and/or a client computer (in a client-server architecture). Moreover, network 112 (FIG. 1) may include: the Internet, World Wide Web (WWW), an intranet, a cellular-telephone network, LAN, WAN, MAN, or a combination of networks, or other technology enabling communication between computing systems.

System 100 (FIG. 1), computer system 900 and/or data structure 1000 (FIG. 10) may include fewer components or additional components. Moreover, two or more components may be combined into a single component, and/or a position of one or more components may be changed. In some embodiments, the functionality of system 100 (FIG. 1) and/or computer system 900 may be implemented more in hardware and less in software, or less in hardware and more in software, as is known in the art.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. A computer-system-implemented method for associating a subset of users of a social network with a target group, the method comprising:
accessing information about previous advertising campaigns, wherein the information for a given previous advertising campaign specifies a target group and one or more associated feedback metrics obtained from individuals;
using the computer system, generating a machine-learning model based on the accessed information and attributes in profiles of the users of the social network, wherein the social network facilitates interactions among the users;
calculating scores for the users indicating probabilities of their responding to a future advertising campaign for the target group based on the machine-learning model and the attributes in the profiles of the users; and
associating the subset of the users with the target group based on the calculated scores.

2. The method of claim 1, wherein the one or more associated feedback metrics include at least one of: a number of views of advertisements associated with the given previous advertising campaign, a number of clicks on the advertisements associated with the given previous advertising campaign, and a number of completed transactions after clicking on the advertisements associated with the given previous advertising campaign.

3. The method of claim 1, wherein the machine-learning model is further based on how often the users log in to the social network.

4. The method of claim 1, wherein the attributes for a given user include at least one of: a frequency of searches conducted by the given user, how often the given user checks who viewed their profile in the social network, and how often the given user views profiles of other users in the social network.

5. The method of claim 1, wherein the attributes for a given user include a number of Internet Protocol addresses associated with different geographic locations for the given user within a time interval.

6. The method of claim 1, wherein the interactions among the users specify a social graph in which nodes correspond to the users and edges between the nodes correspond to the interactions.

7. The method of claim 1, wherein associating the subset of the users with the target group involves ranking the users based on the calculated scores.

8. A computer-program product for use in conjunction with a computer, the computer-program product comprising a non-transitory computer-readable storage medium and a computer-program mechanism embedded therein, to associate a subset of users of a social network with a target group, the computer-program mechanism including:
instructions for accessing information about previous advertising campaigns, wherein the information for a given previous advertising campaign specifies a target group and one or more associated feedback metrics obtained from individuals;
instructions for generating a machine-learning model based on the accessed information and attributes in profiles of the users of the social network, wherein the social network facilitates interactions among the users;
instructions for calculating scores for the users indicating probabilities of their responding to a future advertising campaign for the target group based on the machine-learning model and the attributes in the profiles of the users; and
instructions for associating the subset of the users with the target group based on the calculated scores.

9. The computer-program product of claim 8, wherein the one or more associated feedback metrics include at least one of: a number of views of advertisements associated with the given previous advertising campaign, a number of clicks on the advertisements associated with the given previous advertising campaign, and a number of completed transactions after clicking on the advertisements associated with the given previous advertising campaign.

10. The computer-program product of claim 8, wherein the machine-learning model is further based on how often the users log in to the social network.

11. The computer-program product of claim 8, wherein the attributes for a given user include at least one of: a frequency of searches conducted by the given user, how often the given user checks who viewed their profile in the social network, and how often the given user views profiles of other users in the social network.

12. The computer-program product of claim 8, wherein the attributes for a given user include a number of Internet Protocol addresses associated with different geographic locations for the given user within a time interval.

13. The computer-program product of claim 8, wherein the interactions among the users specify a social graph in which nodes correspond to the users and edges between the nodes correspond to the interactions.

14. The computer-program product of claim 8, wherein associating the subset of the users with the target group involves ranking the users based on the calculated scores.

15. A computer, comprising:
a processor;
memory; and
a program module, wherein the program module is stored in the memory and configurable to be executed by the processor to associate a subset of users of a social network with a target group, the program module including:
instructions for accessing information about previous advertising campaigns, wherein the information for a given previous advertising campaign specifies a target group and one or more associated feedback metrics obtained from individuals;
instructions for generating a machine-learning model based on the accessed information and attributes in profiles of the users of the social network, wherein the social network facilitates interactions among the users;
instructions for calculating scores for the users indicating probabilities of their responding to a future advertising campaign for the target group based on the machine-learning model and the attributes in the profiles of the users; and
instructions for associating the subset of the users with the target group based on the calculated scores.

16. The computer system of claim 15, wherein the one or more associated feedback metrics include at least one of: a number of views of advertisements associated with the given previous advertising campaign, a number of clicks on the advertisements associated with the given previous advertising campaign, and a number of completed transactions after clicking on the advertisements associated with the given previous advertising campaign.

17. The computer system of claim 15, wherein the machine-learning model is further based on how often the users log in to the social network.

18. The computer system of claim 15, wherein the attributes for a given user include at least one of: a frequency of searches conducted by the given user, how often the given user checks who viewed their profile in the social network, and how often the given user views profiles of other users in the social network.

19. The computer system of claim 15, wherein the attributes for a given user include a number of Internet Protocol addresses associated with different geographic locations for the given user within a time interval.

20. The computer system of claim 15, wherein the interactions among the users specify a social graph in which nodes correspond to the users and edges between the nodes correspond to the interactions.
